(19) United States
(12) Patent Application Publication
(10) Pub. No.: US 2010/0254617 A1
(43) Pub. Date: Oct. 7, 2010

(54) APPARATUS AND METHOD TO ROTATE AN IMAGE

(75) Inventors: HAU HWANG, San Diego, CA (US); SHIZHONG LIU, San Diego, CA (US); JOSEPH CHEUNG, San Diego, CA (US); HYUNG COOK KIM, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/416,850

(22) Filed: Apr. 1, 2009

(51) Int. Cl. G06K 9/36; G06K 9/32

(52) U.S. Cl. 382/232; 382/296; 382/235

(57) ABSTRACT

Image processing systems and methods are disclosed. In a particular embodiment, a method is disclosed that includes receiving image data of an image. The image data includes a plurality of image blocks. The method further includes calculating a first differential DC value during a rotation operation of the image by comparing a first DC coefficient value of a first block of a first row of the image to a second DC coefficient value of a first block of a second row of the image. The method further includes storing the first differential DC value in a memory prior to completing the rotation operation.

### FIELD

The present disclosure is generally related to an apparatus and method to rotate an image.

### DESCRIPTION OF RELATED ART

Advances in technology have resulted in smaller and more powerful computing devices. For example, there currently exist a variety of portable personal computing devices that are small, light weight, and easily carried by users, such as personal digital assistants (PDAs), wireless telephones, and paging devices. Portable wireless telephones, such as cellular telephones and internet protocol (IP) telephones, can communicate voice and data packets over wireless networks. Further, many such wireless telephones include other types of devices that are incorporated therein. For example, a wireless telephone may also include a digital still camera, a digital video camera, a digital recorder, and an audio file player. Such wireless telephones can execute instructions of software applications, such as a web browser application, to access the Internet. Therefore, wireless telephones can include significant computing capabilities.

Digital signal processors (DSPs), image processors, and other processing devices are frequently used in portable personal computing devices that include digital cameras or that display image or video data captured by a digital camera. Such processing devices can be utilized to provide video and audio functions, to process received data such as captured image data, or to perform other functions.

In many imaging applications, it may be desired to rotate an image. For example, an image is captured by a camera that is configured to be usually held by the user in a landscape orientation but the user may rotate the camera ninety degrees to capture an image in a portrait orientation. Once the image in the portrait orientation is captured, it may be desirable to rotate the image data by ninety degrees in an opposite direction. Conventional rotation techniques used to rotate the image may be memory intensive because the techniques may involve temporary storage of one or more copies of an uncompressed image and storage of a compressed image before and after the rotation.

### SUMMARY

Embodiments of the present disclosure provide rotation of a captured image by rotating individual units or blocks of an image as each of the blocks is encoded to form the image. Thus, instead of capturing and encoding a complete image and then rotating the image, which is processing-intensive and also consumes memory because at least portions of the original and rotated images will be stored simultaneously, embodiments of the disclosure generate a single, rotated image as the image is encoded. A rotated bit stream is arranged to form the rotated image. In some embodiments, differential encoding is performed in rotation order by a Joint Photographic Expert Group (JPEG) encoder. In other embodiments, JPEG restart (RST) markers are overwritten to indicate a number of padding bits to enable efficient differential encoding by a transcoder.

In a particular embodiment, a method is disclosed that includes receiving image data of an image where the image data includes a plurality of image blocks. The method further includes calculating a first differential DC value during a rotation operation of the image by comparing a first DC coefficient value of a first block of a first row of the image to a second DC coefficient value of a first block of a second row of the image. The method further includes storing the first differential DC value in a memory prior to completing the rotation operation.

In another particular embodiment, an apparatus is disclosed. The apparatus includes a block rotation module configured to receive image data of an image. The image data includes a plurality of image blocks. The apparatus also includes a differential DC calculation module coupled to the block rotation module and configured to calculate a differential DC value during a rotation operation of the image by comparing a first DC coefficient value of a first block of a first portion of the image to a second DC coefficient value of a first block of a second portion of the image.

In another particular embodiment, an apparatus is disclosed. The apparatus includes means for receiving image data of an image having image blocks. The apparatus further includes means for calculating a first differential DC value during a rotation operation of the image by comparing a first DC coefficient value of a first block of a first portion of the image to a second DC coefficient value of a first block of a second portion of the image. The means for calculating a first differential DC value is coupled to the means for receiving image data.

In another particular embodiment, a computer readable storage medium is disclosed. The computer readable storage medium stores code executable by a computer to store a first DC coefficient value of a first block of a first portion of an image during a rotation operation of the image. The computer readable storage medium further includes code executable by the computer to compare a second DC coefficient value of a first block of a second portion of the image to the first DC coefficient value to calculate a first differential DC value. The computer readable storage medium further includes code executable by the computer to store the first differential DC value prior to completing the rotation operation.

One particular advantage provided by embodiments of the apparatus and method to rotate an image is more efficient use of memory.

### BRIEF DESCRIPTION OF THE DRAWINGS

FIG. 1 is a block diagram of a particular illustrative embodiment of a system including an image processing system having a rotation operation module operable to use rotation order differential encoding;

FIG. 2 is a block diagram of a first particular embodiment of an image rotation system;

FIG. 3 is a block diagram of a portion of the image rotation system of FIG. 2;

FIG. 4 is a block diagram of a second particular embodiment of an image rotation system;

FIG. 5 is a block diagram of a third particular embodiment of an image rotation system;

FIG. 6 is a block diagram of a fourth particular embodiment of an image rotation system;

FIG. 76 is a block diagram of a fifth particular embodiment of an image rotation system;

FIG. 8 is a diagram illustrating a particular embodiment of block process order and block scan order for various degrees of image rotation;

FIG. 9 is a diagram illustrating a particular embodiment of block process order and block scan order for horizontal and vertical image flips;

FIG. 10 is a flow diagram of a first illustrative embodiment of a method of rotating an image;

FIG. 11 is a flow diagram of a second illustrative embodiment of a method of rotating an image;

FIG. 12 is a block diagram of a portable communication device including a rotation operation module using rotation order differential encoding; and

FIG. 13 is a block diagram of particular embodiment of an image sensor device including a rotation operation module using rotation order differential encoding.

### DETAILED DESCRIPTION

Rotation of an image is desirable in many imaging applications. Conventional rotation techniques may be memory intensive and may involve temporary storage of one or more copies of an uncompressed image and storage of a compressed image before and after the rotation. By using rotation order differential encoding during a rotation operation as disclosed by embodiments herein, more efficient use of memory may be realized. For example, a re-ordering of the image blocks for a 90 degree rotation may result in the rows of the original image forming columns of the rotated image, and the columns of the original image forming rows of the rotated image. By differentially encoding the image data in the rotation order (i.e. along columns rather than along rows) during the rotation operation, a later differential encoding operation need not be performed after the block reordering. Thus, additional processing to decode and retrieve the DC coefficients after encoding and storing to the memory, such as by a transcoder, may be avoided.

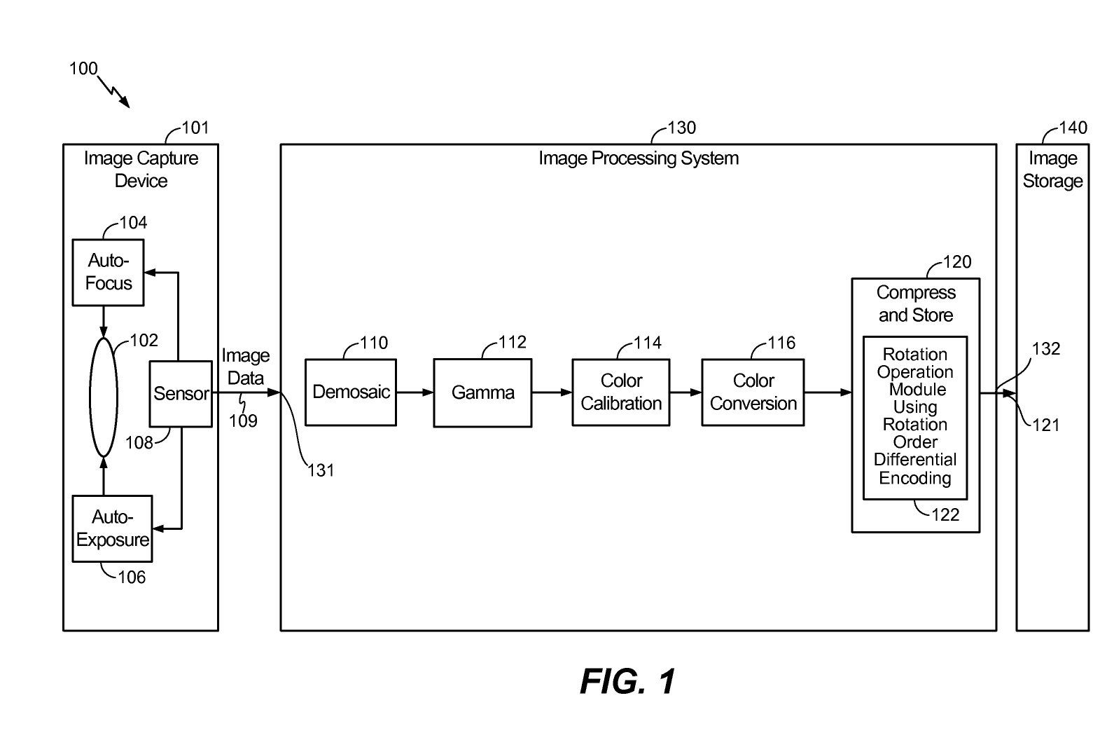

Referring to FIG. 1, a particular illustrative embodiment of a system including an image processing system having a rotation operation module that uses rotation order differential encoding is depicted and generally designated 100. The system 100 includes an image capture device 101 coupled to an image processing system 130. The image processing system 130 is coupled to an image storage device 140. The image processing system 130 is configured to receive image data 109 from the image capture device 101 and to perform a rotation operation to rotate an image represented by the image data 109. In a particular embodiment, the system 100 is implemented in a portable electronic device configured to perform real-time image processing using limited processing resources.

In a particular embodiment, the image capture device 101 is a camera, such as a video camera or a still camera. The image capture device 101 includes a lens 102 that is responsive to an auto focus module 104 and to an auto expose module 106. A sensor 108 is coupled to receive light via the lens 102 and to generate the image data 109 in response to an image received via the lens 102. The auto focus module 104 is responsive to the sensor 108 and is adapted to automatically control focusing of the lens 102. The auto exposure module 106 may also be responsive to the sensor 108 and is adapted to control an exposure of the image. In a particular embodiment, the sensor 108 includes multiple detectors that are arranged so that adjacent detectors detect different colors of light. For example, received light may be filtered so that each detector receives red, green, or blue incoming light.

The image capture device 101 is coupled to provide the image data 109 to an input 131 of the image processing system 130. The image processing system 130 is responsive to the image data 109 and includes a demosaic module 110. The image processing system 130 also includes a gamma module 112 to generate gamma corrected data from data that is received from the demosaic module 110. A color calibration module 114 is coupled to perform a calibration on the gamma corrected data. A color space conversion module 116 is coupled to convert an output of the color calibration module 114 to a color space. A compress and store module 120 is coupled to receive an output of the color space conversion module 116 and to store compressed output data 121 to the image storage device 140. A rotation operation module 122 is coupled to perform a rotation operation on the image received via the image data 109 using rotation order differential encoding.

The image storage device 140 is coupled to an output 132 and is adapted to receive and store the compressed output data 121. The image storage device 140 may include any type of storage medium, such as one or more display buffers, registers, caches, flash memory elements, hard disks, any other storage device, or any combination thereof.

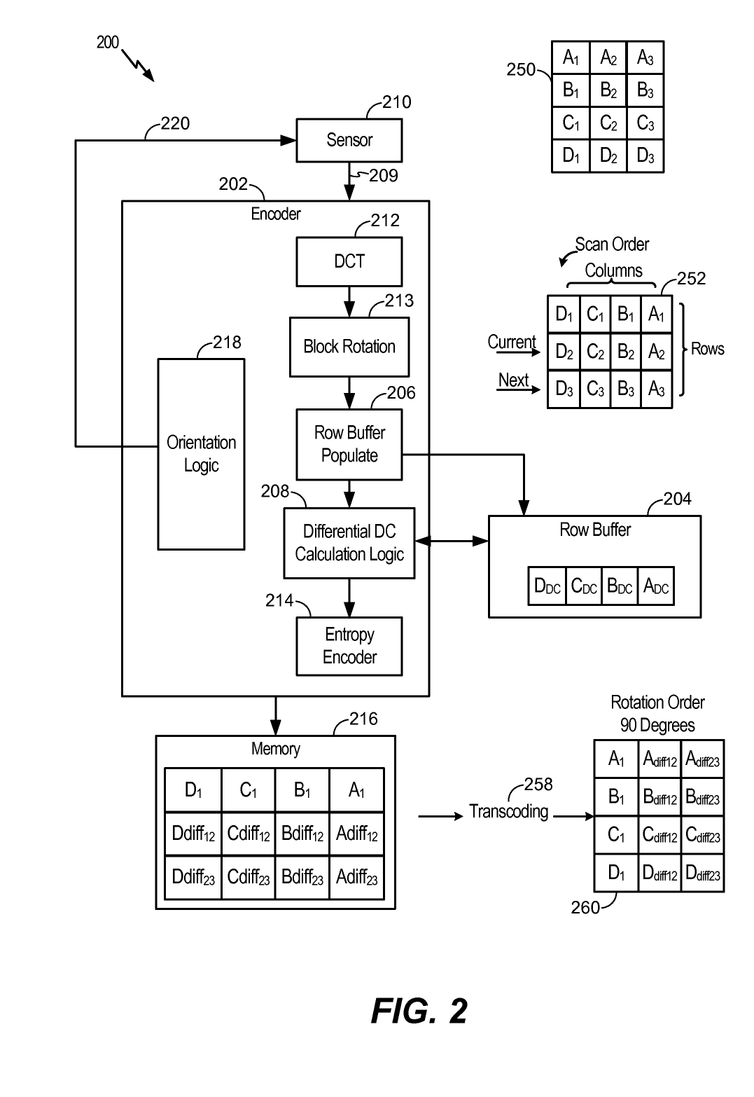

During operation, the rotation operation module 122 may efficiently perform a rotation of the input image data 109. For example, the rotation operation module 122 may perform an image rotation as will be described with respect to FIGS. 2-10. The rotation operation module 122 may reorder minimum coded units (MCUs) of an image encoded by an encoder and rotate image data within the MCUs such that the reordering of the MCUs and rotation of the image data generate a rotated version of the encoded image. After generating the rotated version of the encoded image, the rotation operation module 122 may output the rotated version of the encoded image to the image storage device 140. The MCUs may comprise blocks of Discrete Cosine Transform (DCT) coefficients coded according to a Joint Photographic Expert Group (JPEG) standard.

The rotation operation module 122 may receive image data that includes a plurality of image blocks. The rotation operation module 122 is configured to calculate a first differential DC value. For example, the rotation operation module 122 may compare a first DC coefficient value of a first block of a first portion of the image to a second DC coefficient value of a first block of a second portion of the image during a rotation operation of the image and store the first differential DC value prior to completing the rotation operation. In one particular illustrative embodiment, the first portion and the second portion of the image data 109 may include a first row and a second row of the image data 109, respectively. Alternatively, the first portion and the second portion may include a first column and a second column of the image data 109, or some other layer or segment of the image data 109.

Referring to FIG. 2, a particular illustrative embodiment of a system including an encoder configured to perform a rotation operation is depicted and generally designated 200. The system 200 includes a sensor 210 coupled to an encoder 202. The encoder 202 is coupled to a memory 216. The encoder 202 is also coupled to a buffer, such as a row buffer 204. In a particular embodiment, the encoder 202 is part of the rotation operation module 122 of FIG. 1 and is configured to perform a transcoding operation to reorder blocks in the image to generate the rotated image.

The encoder 202 includes a discrete cosine transfer (DCT) module 212, a block rotation module 213, a row buffer populate module 206, a differential DC calculation logic module 208, an entropy encoder module 214, and an orientation logic module 218. The orientation logic module 218 is coupled to the sensor 210. The DCT module 212 is coupled to the block rotation module 213. The row buffer populate module 206 is coupled to the block rotation module 213. The differential DC calculation logic module 208 is coupled to the row buffer populate module 206. The row buffer 204 is coupled to the row buffer populate module 206 and is coupled to the differential DC calculation logic module 208. The entropy encoder 214 is coupled to the differential DC calculation logic module 208. As previously mentioned, the portions of image data to be rotated may include rows, columns, or other portions of the image data. However, for purposes of this description, an example in which the portions constitute rows of the image data will be used. Thus, the differential DC calculation logic module 208 is coupled to the row buffer populate module 206, rather than a column buffer populate module or another buffer populate module.

The encoder 202 is configured to receive image data 209 from the sensor 210 and to perform a rotation operation to rotate an image received as the image data 209. As previously described, rotation may be advantageous in digital camera devices where image data is generated in the same scan-line order regardless of whether the user orients the camera device in a landscape or portrait orientation. For at least one of these orientations, a ninety (90) degree, one-hundred-eighty (180) degree, or two-hundred-seventy (270) degree rotation of the captured image may be desirable prior to storing the image.

In a particular embodiment, the encoder 202 is a Joint Photographic Expert Group (JPEG) encoder. The encoder 202 includes the orientation logic module 218. The orientation logic module 218 is configured to determine an orientation of the sensor 210 and to generate a rotation signal 220. The sensor 210 may be responsive to the rotation signal 220 to adjust a scan order to generate the image data 209, and the rotation signal 220 may also be included with the image data 209 received at an input of the encoder 202.

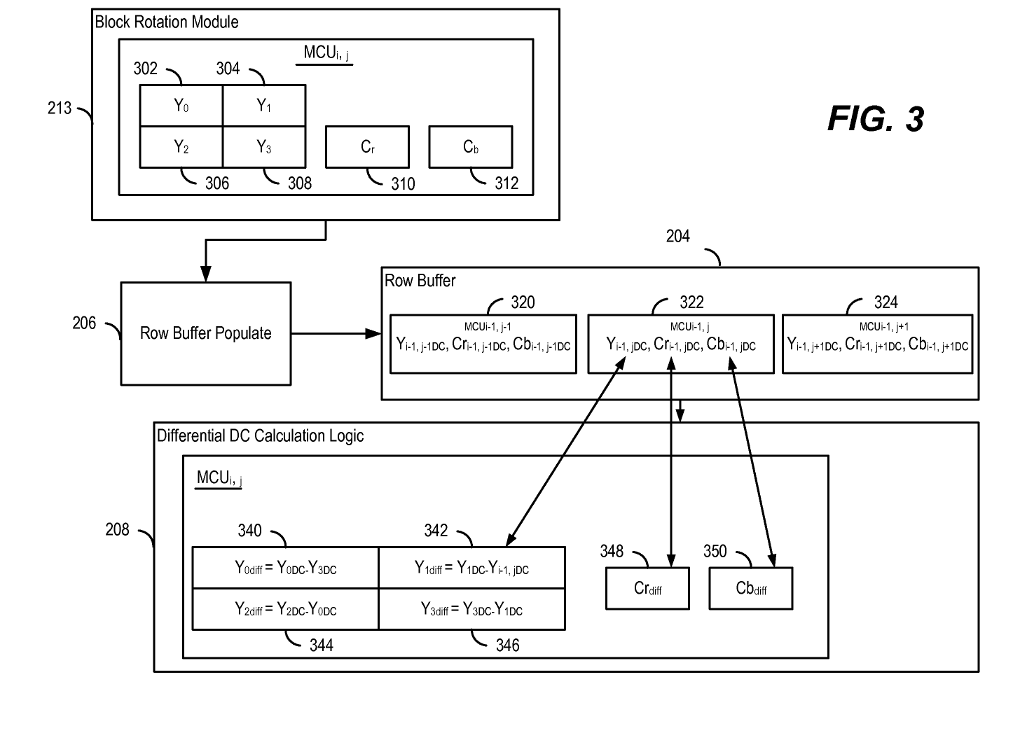

In a particular embodiment, the image data 209 includes a plurality of minimum coded units (MCUs). The DCT module 212 is configured to generate blocks of DCT coefficients. The MCUs may comprise blocks of DCT coefficients coded from blocks of pixels of the image via discrete cosine transformation. The blocks of DCT coefficients may include luma (Y) blocks and chroma (Cr, Cb) blocks, as will be discussed with respect to FIG. 3. The block rotation module 213 is configured to receive the blocks of DCT coefficients and to generate block rotated data. The row buffer populate module 206 is coupled to perform a row buffer populate operation using the block rotated data. The row buffer 204 is coupled to receive an output of the row buffer populate module 206. An entropy encoder module 214 is coupled to compress an output of the differential DC calculation logic module 208. The memory 216 is configured to store entropy-encoded blocks generated by the entropy encoder module 214, including a first block having a first differential DC value and a second block having a second differential DC value.

In a particular embodiment, the row buffer populate module 206, the row buffer 204, and the differential DC calculation module 208 interoperate to store most recently coded DC coefficient information for each particular column of the image. The most recently coded DC coefficient information for each column is retrieved by the differential DC calculation module 208 and updated by the row buffer populate module 206 as new MCUs of the column are received according to the scan order of the sensor 210. An example of operation of the row buffer populate module, the row buffer 204, and the differential DC calculation logic module 208 is depicted in FIG. 3.

By using the row buffer 204 to store the prior DC coefficient value for each column of the image, the encoder 202 can perform rotation order differential encoding for ninety degree (90) or two-hundred-seventy degree (270) rotations. For example, while a scan order differential encoding operation may use a DC value of a prior block in a particular row to determine a differential value of a next block in the particular row, a rotation order differential encoding operation for ninety (90) degree and two-hundred-seventy (270) degree rotations generate differential values based on a prior block in the same column as the particular block. Thus, the row buffer 204 maintains data corresponding to a most recently encoded block of each column of the image to enable differential encoding along each column of the image.

For example, in an embodiment where the system 200 is implemented in a camera configured to be usually held by the user in a landscape orientation but the user rotates the camera ninety (90) degrees to capture an image in a portrait orientation, then the multiple rows and multiple columns of image blocks 250 of the original image may be rotated ninety (90) degrees. In a particular embodiment, a portion of the image that the user sees through the viewfinder of the camera may be represented as image blocks 250. When the camera is rotated ninety (90) degrees, the image captured at the sensor 210 may be rotated ninety (90) degrees such that the rows of the original image form columns of the rotated image as illustrated by the image blocks 252. After differentially encoding the image in the rotation order (i.e. along columns rather than along rows) during the rotation operation, the image may be re-ordered in the original image order as illustrated by image blocks 260.

For illustrative purposes and in a particular embodiment, the image blocks of row 1 of the image blocks 250 of the original image prior to rotation may be A₁A₂A₃. The image blocks of row 2 may be B₁B₂B₃; the image blocks of row 3 may be C₁C₂C₃; and the image blocks of row 4 may be D₁D₂D₃. Although illustrated and described as “image blocks” for ease of explanation, in other embodiments each “image block” may represent one or more blocks of the image. For example, in an embodiment using JPEG encoding, each “image block” may represent a MCU that includes multiple blocks, such as luma (Y) blocks and chroma (Cr, Cb) blocks as discussed with respect to FIG. 3. A re-ordering of the image blocks 252 for a ninety (90) degree rotation may result in the rows of the original image forming columns of the rotated image, and the columns of the original image forming rows of the rotated image. For example, the image blocks of row 1 of the rotated image may be A₁B₁C₁D₁; the image blocks of row 2 of the rotated image may be A₂B₂C₂D₂; and the image blocks of row 3 of the rotated image may be A₃B₃C₃D₃. The resulting rotated order of the image blocks for a ninety (90) degree rotation is illustrated at 260.

After a transcoding operation 258, as performed by the encoder 202 as previously described, the image blocks may be re-ordered in the original image order and contain differentially encoded data (i.e. row 1: A₁A_{diff12}A_{diff23}; row 2: B₁B_{diff12}B_{diff23}; row 3: C₁C_{diff12}C_{diff23}; row 4: D₁D_{diff12}D_{diff23}). For example, A_{diff12} corresponds to the difference between one or more DC coefficient values of a first block A₁ of a first row and one or more DC coefficient values of a first block A₂ of a second row; A_{diff23} corresponds to the difference between one or more DC coefficient values of the first block A₂ of the second row and one or more DC coefficient values of a first block A₃ of a third row; etc. To illustrate, the DC coefficient values may correspond to DC coefficient values of particular luma and chroma blocks within the first image block A₁ of the first row and particular luma and chroma blocks within the first image block A₂ of the second row, as discussed with respect to FIG. 3.

By differentially encoding the image data in the rotation order (i.e., along columns rather than along rows) during the rotation operation, a later differential encoding operation need not be performed after the block reordering. Thus, additional processing to decode and retrieve the DC coefficients after encoding and storing to the memory may be avoided. In a particular embodiment, the transcoding operation 258 is performed by the encoder 202. In another particular embodiment, the transcoding operation 258 may be performed by a separate transcoder module.

Referring to FIG. 3, a particular embodiment of a portion of the image rotation system of FIG. 2 is depicted and generally designated 300. The system 300 includes the block rotation module 213, the row buffer populate module 206, the row buffer 204, and the differential DC calculation logic module 208. Contents of the block rotation module 213, the row buffer 204, and the differential DC calculation module 208 are illustrated for a ninety (90) degree image rotation.

The block rotation module 213 rotates pixel transform data within each block of a received MCU. The block rotation module 213 is depicted as including data corresponding to an i-th row and a j-th column of the image, indicated as MCU_{i, j}. In a particular embodiment, MCU_{i, j} includes a plurality of blocks, including four luma (Y) blocks Y₀ 302, Y₁ 304, Y₂ 306, Y₃ 308, and two chroma blocks Cr 310 and Cb 312.

The row buffer 204 includes most recently coded DC coefficient values for a plurality of particular columns of the image. As illustrated, the row buffer 204 includes the most recently coded DC coefficient values for MCUs of the prior, same, and next columns of the prior row of the image relative to the MCU_{i, j} indicated as MCU_{i-1, j-1} 320, MCU_{i-1, j} 322, and MCU_{i-1, j+1} 324, respectively. For example, a row buffer entry MCU_{i-1, j-1} 320 includes a DC coefficient value of a last processed luma block (Y_{i-1, j-1DC}), a DC coefficient value of a last processed chroma red block (Cr_{i-1, j-1DC}), and a DC coefficient value of a last processed chroma blue block (Cb_{i-1, j-1DC}) of the MCU 320. A row buffer entry MCU_{i-1, j} 322 includes a DC coefficient value of a last processed luma block (Y_{i-1, jDC}), a DC coefficient value of a last processed chroma red block (Cr_{i-1, jDC}), and a DC coefficient value of a last processed chroma blue block (Cb_{i-1, jDC}) of the MCU 322. A row buffer entry MCU_{i-1, j+1} 324 includes a DC coefficient value of a last processed luma block (Y_{i-1, j+1DC}), a DC coefficient value of a last processed chroma red block (Cr_{i-1, j+1DC}), and a DC coefficient value of a last processed chroma blue block (Cb_{i-1, j-1DC}) of the MCU 324.

The differential DC calculation module 208 is configured to differentially encode DC coefficient values of each MCU in a rotation order. For example, the differential DC calculation module 208 is configured to access the DC coefficient values of the prior MCU for a particular column stored at the row buffer 204 to encode a first differential DC value for a current MCU of the column. As illustrated, the differential DC calculation module 208 includes a differentially coded version of the MCU_{i, j} from the block rotation module 213, including luma blocks 340, 342, 344, 346 and chroma blocks 348 and 350.

During operation, the row buffer populate module 206, the row buffer 204, and the differential DC calculation module 208 interoperate to store a most recently coded DC coefficient of Y, Cr, and Cb, for each particular column of the image. The most recently coded DC coefficient for each column is retrieved by the differential DC calculation module 208 and updated by the row buffer populate module 206 as new MCUs of the column are received according to the scan order of the image sensor (not shown).

For example, block processing order of blocks of a particular MCU may be based on a degree of rotation as illustrated in FIG. 8. When the image sensor is not rotated (e.g., zero (0) degree rotation), the block processing order to differentially encode the blocks of MCU_{i, j} may be left-to-right, top-to-bottom as follows: Y₃ₗₐₛₜ→Y₀→Y₁→Y₂→Y₃→Y₀ₙₑₓₜ; Crₗₐₛₜ→Cr→Crₙₑₓₜ; Cbₗₐₛₜ→Cb→Cbₙₑₓₜ, where last and next indicate the prior MCU and the next MCU along a same row of the image, respectively.

For a ninety (90) degree rotation, a block processing order for luma and chroma (e.g., Y, Cr, Cb) may be top-to-bottom, right-to-left as illustrated in FIG. 8. A differential DC value is calculated for each of the blocks of the particular MCU according to the block processing order for a ninety (90) degree rotation. For example, the block processing order for ninety (90) degrees is Y₂ₗₐₛₜ→Y₁→Y₃→Y₀→Y₂→Y₁ₙₑₓₜ.

The scan order described above for zero (0) degree rotation and ninety (90) degree rotation pertains to each luma and chroma block being encoded separately. In another embodiment, the luma and chroma block may be encoded in an interleaved manner. For example, a zero (0) degree rotation in a two block horizontal two block vertical (H2V2) MCU may be encoded as follows: Y₀, Y₁, Y₂, Y₃, Cb, Cr, Y₀ₙₑₓₜ, Y₁ₙₑₓₜ, Y₂ₙₑₓₜ, Y₃ₙₑₓₜ, Cbₙₑₓₜ, Crₙₑₓₜ, etc.

The resulting differential DC values for the luma blocks 340, 342, 344, and 346 of MCU_{i, j} are as follows: for luma block 342, the differential DC value is calculated by subtracting the DC coefficient value of the last Y block of the prior MCU of the column (e.g., the prior row) from the DC coefficient value of Y₁. The last Y block of the prior MCU of the column is MCU_{i-1, j} 322 of row buffer 204. For a ninety (90) degree rotation, the differential DC value for the luma block 342 is the DC coefficient value of the Y₂ block of the (i−1) row, j-th column subtracted from the DC coefficient value of Y₁, or Y_{1diff}=Y_{1DC}−Y_{i-1, jDC}. The differential DC value for the luma block 346 is calculated by subtracting the DC coefficient value of Y₃ from the DC coefficient value of Y₁, or Y_{3diff}=Y_{3DC}−Y_{1DC}. The differential DC value for luma block 340 is calculated by subtracting the DC coefficient value of Y₃ from the DC coefficient value of Y₀, or Y_{0diff}=Y_{0DC}−Y_{3DC}. The differential DC value for the luma block 344 is calculated by subtracting the DC coefficient value of Y₂ from the DC coefficient value of Y₀, or Y_{2diff}=Y_{2DC}−Y_{0DC}. The differential DC value for the chroma red (Cr) block 348 is calculated by subtracting the DC coefficient of the Cr block of the prior MCU of the column (e.g., the prior row) from the DC coefficient value of Cr, or Cr_{diff}=Cr−Cr_{i-1, jDC}. The differential DC value for the chroma blue (Cb) block 350 is calculated by subtracting the DC coefficient of the last Cb block of the prior MCU of the column (e.g., the prior row) from the DC coefficient value of Cb, or Cb_{diff}=Cb−Cb_{i-1, jDC}.

After encoding, the row buffer populate module 206 populates the row buffer 204 with DC coefficient values from MCU_{i, j}. As illustrated for a ninety (90) degree rotation, DC coefficient values of the last processed blocks, such as the DC coefficient value of Y₂ 306, the DC coefficient value of Cr 310, and the DC coefficient value of Cb 312 may replace values of MCU_{i-1, j} 322. The row buffer 204 may therefore be updated as the image is being processed to enable rotation order differential encoding.

By differentially encoding the image data in the rotation order (i.e., along columns rather than along rows) during the rotation operation, a later differential encoding operation need not be performed after the block reordering. Thus, additional processing to decode and retrieve the DC coefficients after encoding and storing to the memory may be avoided.

Although an example for a ninety (90) degree rotation is described above, differentially encoding the image data in the rotation order during the rotation may also be used for one-hundred eighty degree (180) rotation, for two-hundred seventy (270) degree rotation, as well as for vertical or horizontal flips of the image, as shown in FIG. 8 and FIG. 9.

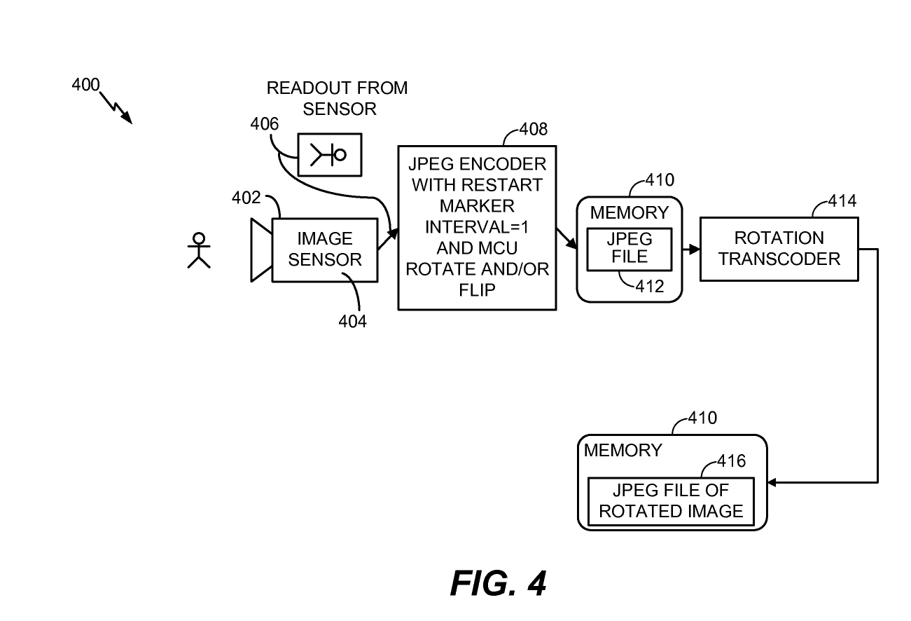

Referring to FIG. 4, a particular embodiment of an image rotation system is depicted and generally designated 400. The system 400 includes an image capture device 402 coupled to a JPEG encoder 408, a memory 410 coupled to the JPEG encoder 408, and a rotational transcoder 414 coupled to the memory 410. The image capture device 402 includes an image sensor 404 configured to capture an image. A readout 406 of image capture device 402 is provided to the JPEG encoder 408.

The JPEG encoder 408 encodes rotated regions of the captured image into independently decodable pieces of compressed data or minimum coded units (MCUs) by inserting codes to separate the independently decodable pieces of compressed data. For JPEG-encoded image data, these codes are restart (RST) markers. A JPEG image contains a sequence of markers, each of which begins with a 0xFF byte followed by a byte indicating what kind of marker it is. The RST markers may include an identifiable bit pattern, such as 0xFFDn. At an RST marker, block-to-block predictor variables are reset and the bit stream is synchronized to a byte boundary.

The compressed rotated image data may be stored out of order, and then a reorder process may order the independently decodable pieces into the correct order such that a traditional decoder can correctly reconstruct the rotated image data and output the correctly ordered compressed image data. As shown in FIG. 4, the JPEG encoder 408 applies an RST marker interval of one. By setting the RST value to one, each MCU in an encoded JPEG file 412 is a separately decodable unit. The encoded JPEG file 412 is stored in the memory 410.

During operation, the JPEG encoder 408 rotates the MCUs generated by the JPEG encoder 408, but does not change MCU order. The output of the JPEG encoder 408 is stored as the JPEG file 412 at the memory 410. The JPEG file 412 may be entropy encoded. The rotational transcoder 414 reorders the MCUs of the JPEG file 412 into a rotation order and stores the result in the memory 410 as a JPEG file of a rotated image 416.

In a particular embodiment, the JPEG encoder 408 and the rotational transcoder 414 rotate image data within the MCUs and an order of the MCUs, respectively. The rotation of the image data within the MCUs and the reordering of the MCUs generate a rotated version of the encoded image. The rotated version of the encoded image can be stored in the memory 410 as the JPEG file of a rotated image 416. The rotational transcoder 414 may fetch the encoded JPEG file 412 from the memory 410 and the encoded image may be coded via an entropy coding technique.

Because the RST markers are identifiable in a resulting JPEG bit stream with MCU rotation, the rotation transcoder 414 can locate each MCU individually. Each MCU can then be indexed, and the MCUs can be fetched in a reordered manner based on the indexing so that the MCUs are positioned in a rotated order relative to the original encoded image.

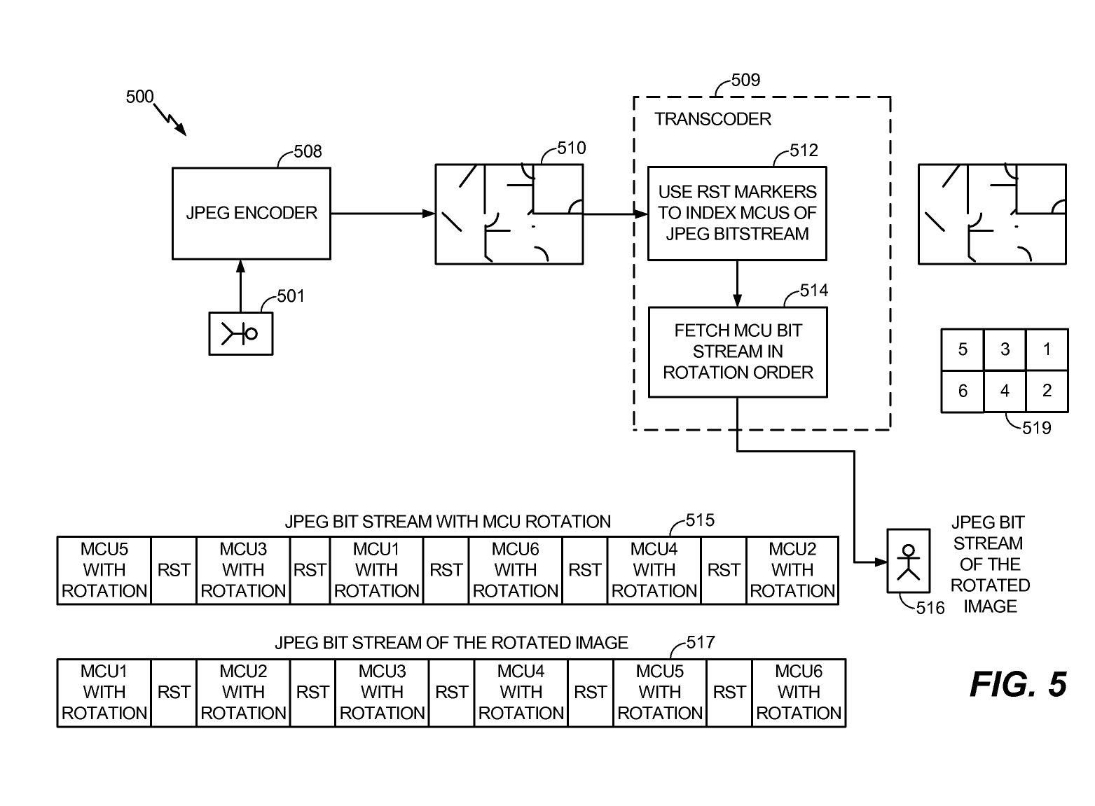

Referring to FIG. 5, another particular embodiment of an image rotation system is depicted and generally designated 500. The system 500 includes an encoder, such as a JPEG encoder 508 coupled to a transcoder 509. The transcoder 509 includes an index module 512 coupled to a reordering module 514. In a particular embodiment using a JPEG encoder, the index module 512 uses RST markers to index MCUs of the JPEG bit stream received from the JPEG encoder 508, and the reordering module 514 fetches an MCU bit stream from a memory (not shown) in rotation order.

The JPEG encoder 508 receives image data 501. A reordering of MCUs and rotation of image data within the MCUs by the JPEG encoder 508 and the transcoder 509 generates a rotated version of the image encoded in the image data 501 and the rotated version can be output to a memory.

Because the RST markers are identifiable in the resulting JPEG bit stream with MCU rotation 515, the transcoder 509 can locate each MCU individually. Each MCU can then be indexed, and the MCUs can be fetched in a reordered manner based on the indexing, so that the MCUs are positioned in a rotated order relative to the original encoded image. Therefore, rather than simply sequentially processing MCUs according to the order in which they appear in the input data stream, MCUs may be extracted from different parts of the compressed image in accordance with the order in which the MCUs will appear in the output data stream. In this way, an encoded image that includes MCUs coded via DCT techniques can be rotated without decoding some or all of the DCT coefficients.

For example, during operation, the JPEG encoder 508 receives the image data 501. The JPEG encoder 508 may generate a JPEG bit stream of the image data 501 with each MCU rotated. In a particular embodiment, the rotated MCUs remain in the original order of the image data 501. The image data with rotated MCUs is schematically illustrated as rotated image data 510 and as JPEG bit stream with MCU rotation 515 representing a ninety degree rotation of each block of a 2 block by 3 block (2×3) image 519. The JPEG encoder 508 may generate a JPEG bit stream in the received order with RST markers following every MCU to be used during indexing and reordering of the bit stream. The transcoder 509 receives the JPEG bit stream from the JPEG encoder 508, and after indexing at the index module 512, and reordering at the reordering module 514, the JPEG bit stream is ordered such that the rotation order performed by the JPEG encoder is correctly decodable by a conventional JPEG decoder. The JPEG bit stream of the rotated image is shown illustratively at 516 and schematically at 517.

Although the indexing and the reordering are described above as occurring within the transcoder 509, in another embodiment the indexing, the reordering, or both the indexing and the reordering may occur within the encoder 508.

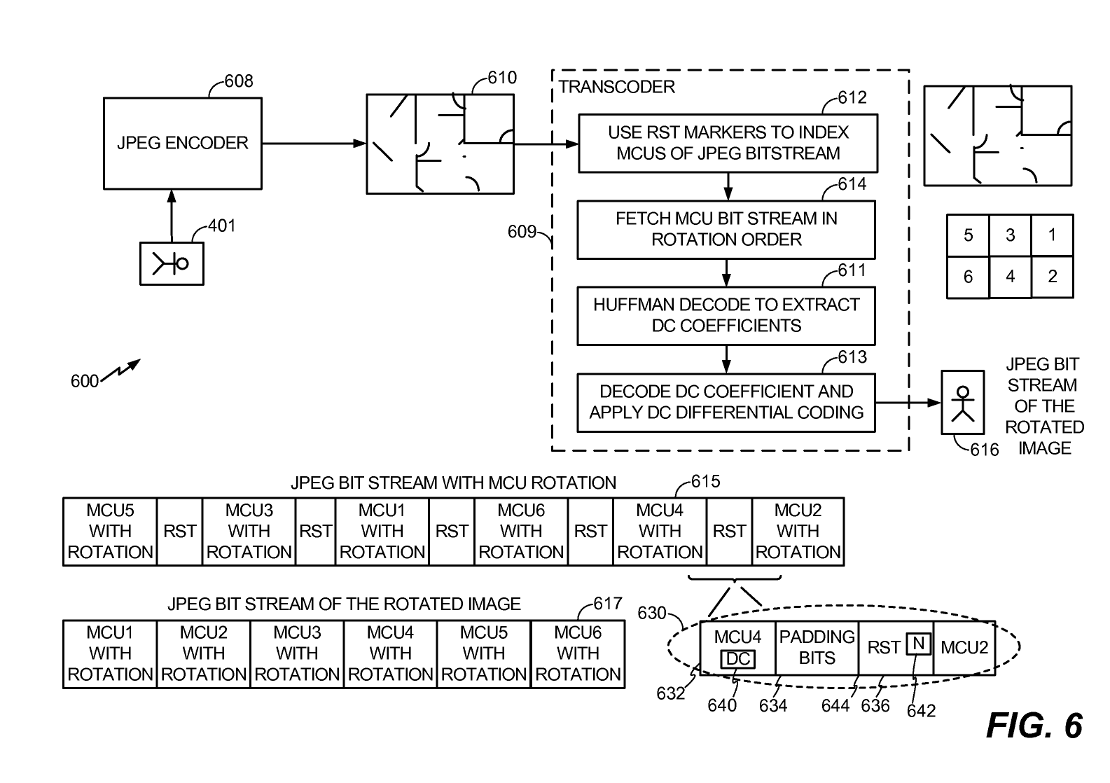

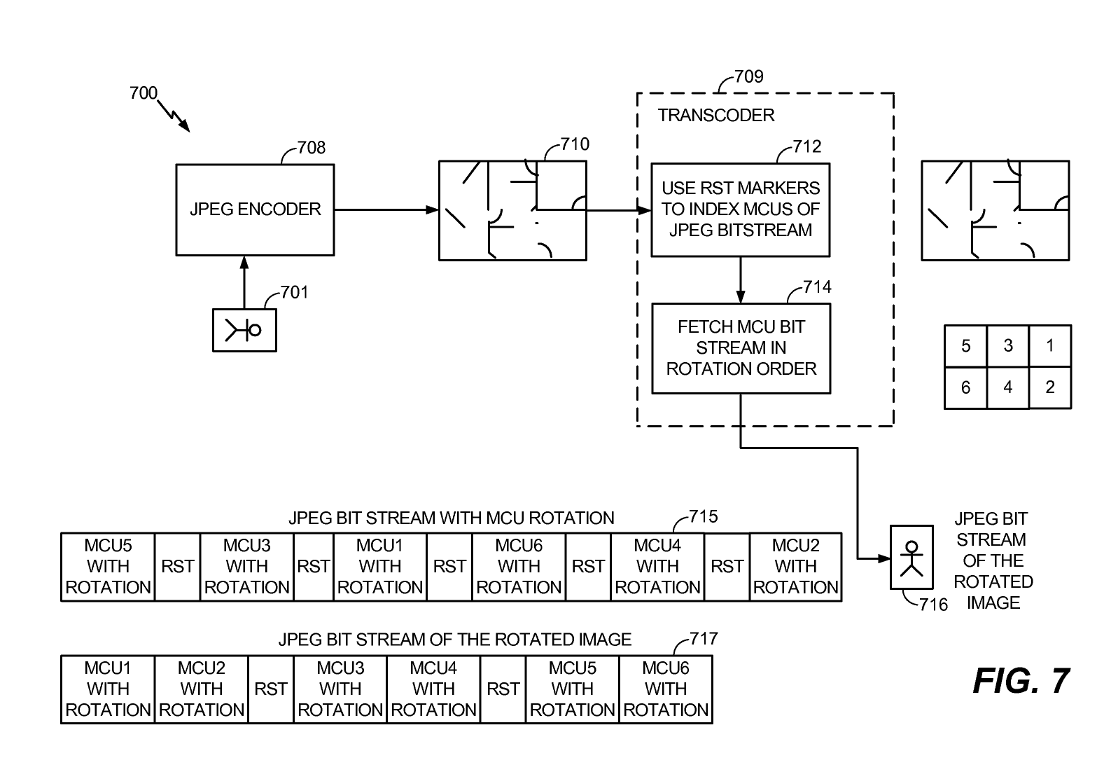

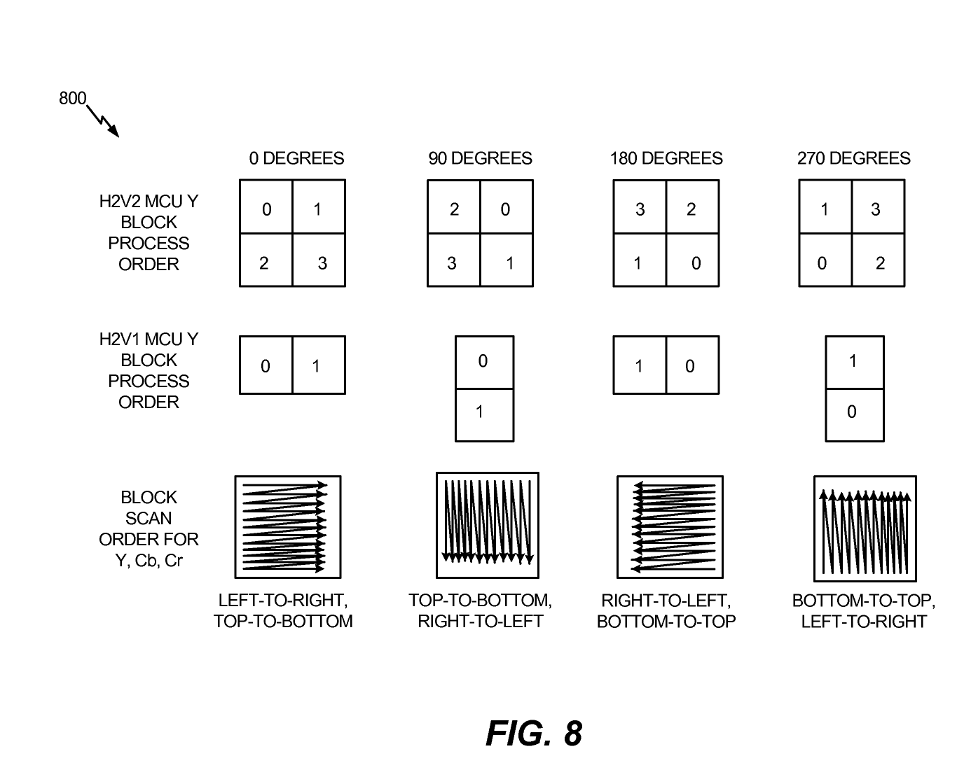

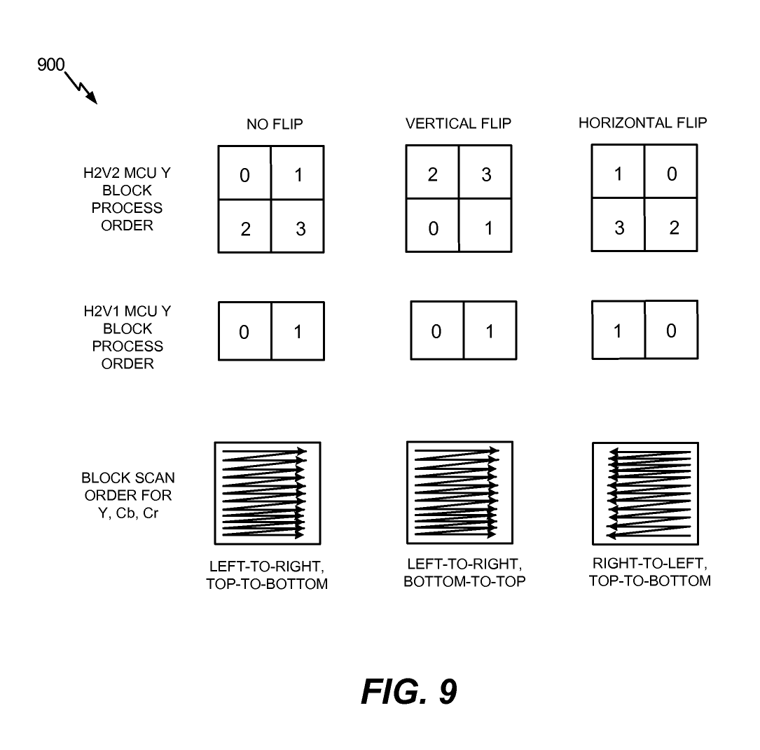

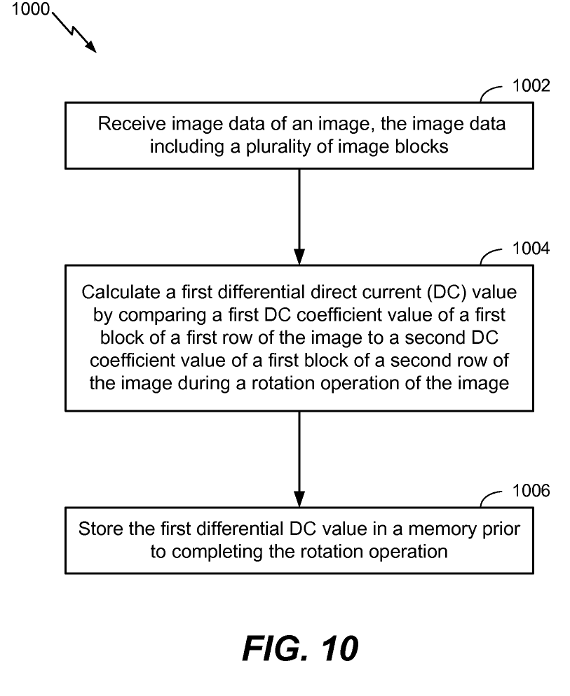

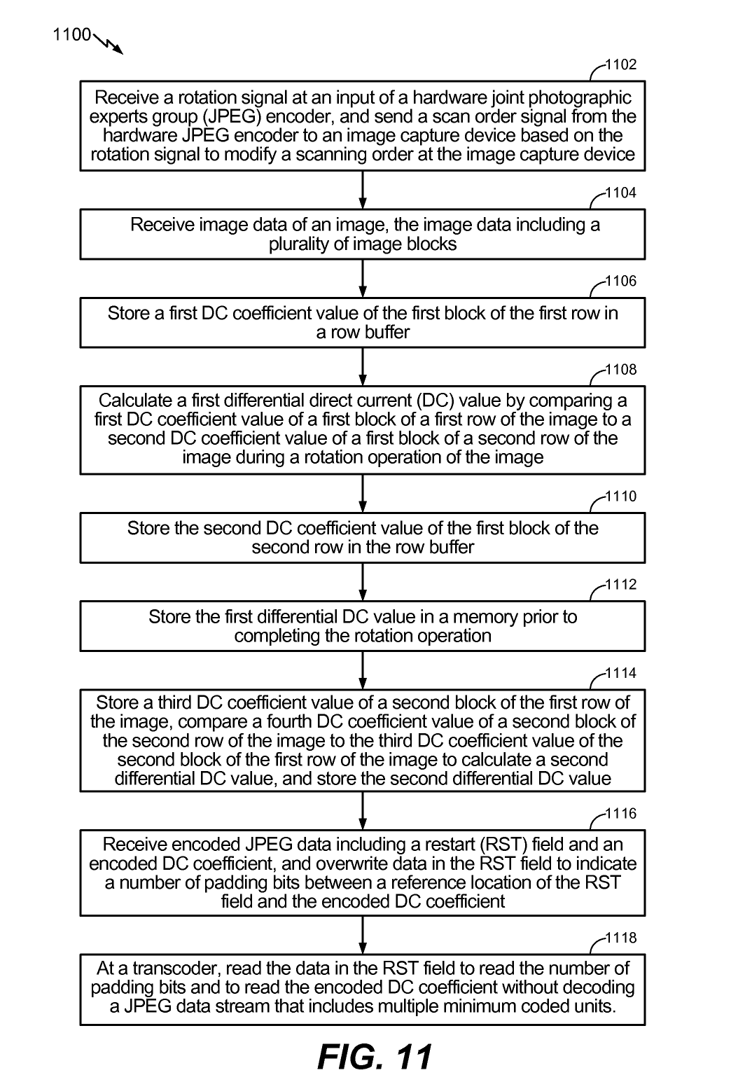

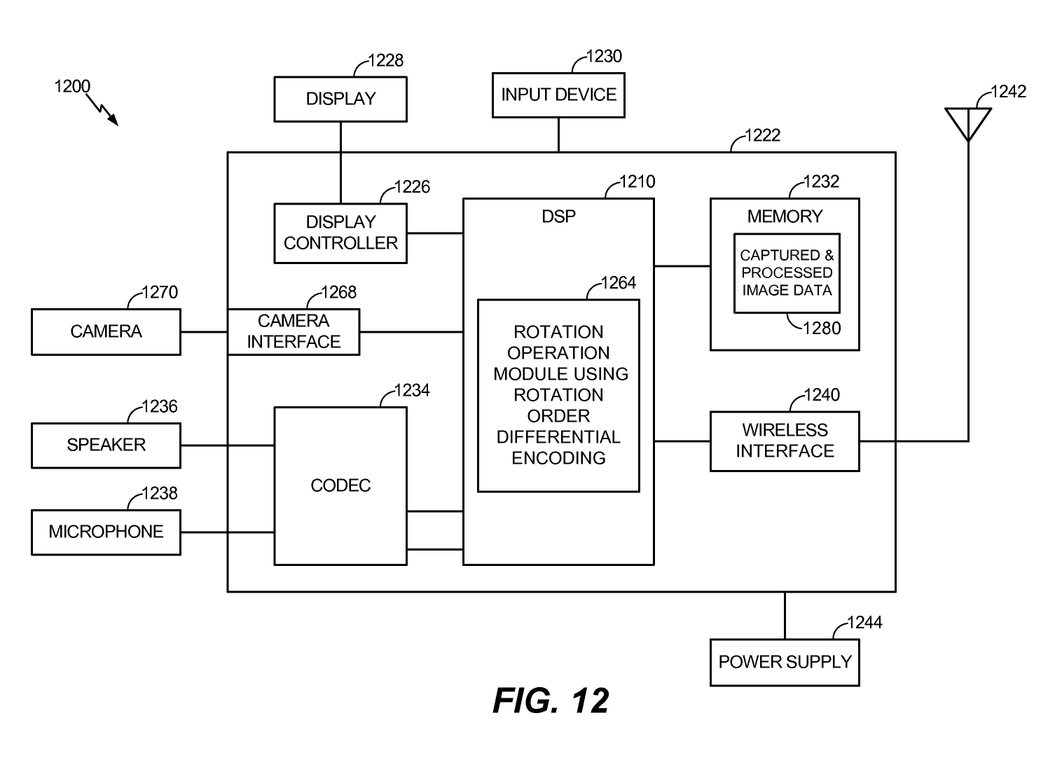

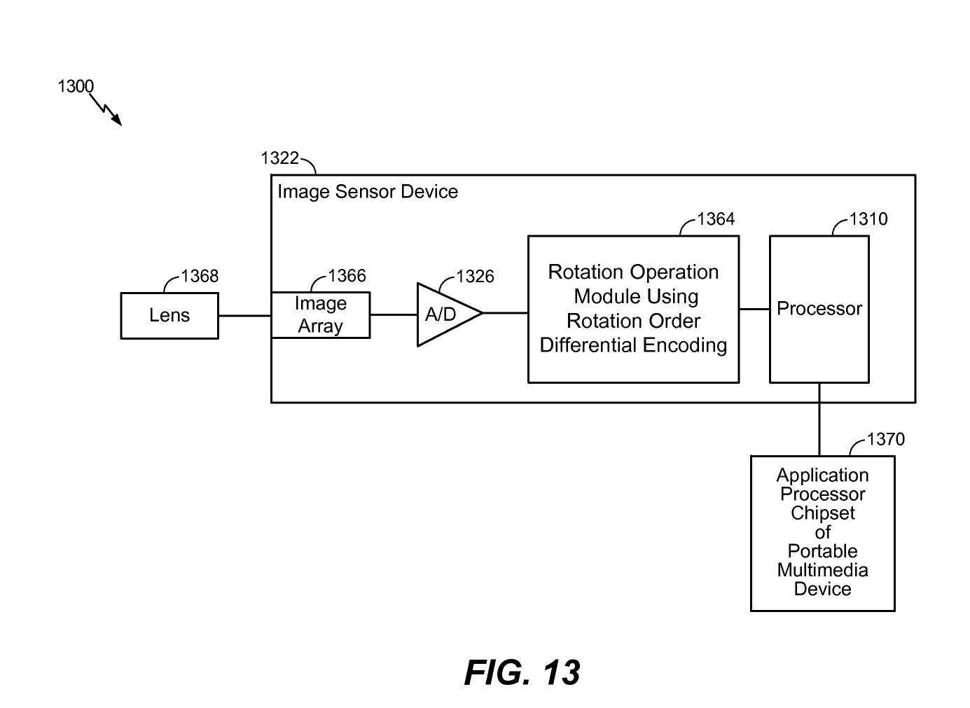

Referring to FIG. 6, another particular embodiment of an image rotation system is depicted and generally designated 600. The system 600 includes a JPEG encoder 608 coupled to a transcoder 609. The transcoder 609 includes an index module 612 coupled to a reordering module 614. The reordering module 614 is coupled to a decode module 611. In a particular embodiment, the decode module 611 is a Huffman decode module. The decode module 611 is coupled to a differential coding module 613.

The JPEG encoder 608 receives image data 601. A reordering of MCUs and rotation of image data within the MCUs by the JPEG encoder 608 and the transcoder 609 generates a rotated version of the image encoded in the image data 601, and the rotated version can be output to a memory. In a particular embodiment, the transcoder 609 retrieves the encoded image block in a readout order. The index module 612 uses RST markers to index MCUs of the JPEG bit stream, the reordering module 614 fetches an MCU bit stream in rotation order, the decode module 611 extracts DC coefficients, and the differential coding module 613 decodes the extracted DC coefficients and applies differential coding.

For example, the transcoder 609 may receive a JPEG bit stream of the image 601 which may have been encoded by JPEG encoder 608. The index module 612 uses RST markers to index MCUs of the JPEG bit stream. Next, the reordering module 614 fetches the MCU bit stream in a rotational order. This reorders the MCUs. The decode module 611 Huffman decodes and inverse zigzag scans each of the MCUs. The process of Huffman decoding and inverse zigzag scanning may be referred to as entropy decoding. Next, the differential coding module 613 may decode only the DC coefficient of each MCU and apply DC differential decoding to each MCU. The DC differential decoding may remove any differential coding that may have been applied to the DC coefficient of the DCT coefficients. To do so may require at least a partial decode of the DC coefficient of each MCU, but in this case, the AC coefficients remain coded in the DCT domain.

In a particular embodiment, such decoding may be assisted by overwriting data stored in restart fields, such as at the RST markers. As illustrated in an exploded portion 630 of the JPEG bit stream with MCU rotation 616, padding bits 634 are inserted between each MCU, such as the MCU4 632, and a next byte boundary 644, with the RST marker 636 aligned to the byte boundary 644. The padding bits 634 are used to align the RST marker to a byte boundary. The MCU4 632 may contain a DC coefficient 640 as a last data element prior to the padding bits 634. The JPEG encoder 608 may overwrite a portion of the data of the RST marker 636, illustrated as a value N 642, to represent the number of padding bits 634. In a particular embodiment, the JPEG encoder 608 may overwrite a default counter value, such as a four-bit portion of the RST marker according to a particular JPEG implementation. The value N 642 may indicate a number of padding bits between an end of a bit stream of the last MCU 632 and the RST marker 636. The number of padding bits encoded in the RST marker 636 enables the end of the previous MCU bit stream to be more easily identified so that sequential MCUs 632 and 648 can be concatenated after the RST marker 636 and padding bits 634 are removed. In addition, DC predictor values 646 for luma (Y) and chroma (Cb, Cr) for the last block in the MCU 648 can be inserted next to the RST marker 636. The DC predictor values 646 may be used to apply differential coding across the MCU boundary so that the RST markers can be removed without having to decode parts of the bit stream.

The MCUs may be reordered according to a specified rotation so that the MCUs are positioned in a rotated order relative to the original encoded image. In order to facilitate this reordering of MCUs, the JPEG encoder 608 may make use of an indexing scheme. For example, in accordance with the JPEG standard, an RST marker value associated with an encoded image may be set to one. The RST markers may indicate where the image data can be restarted and thus independently encoded or decoded. This may result in each DCT coded MCU forming an independently decodable unit of a JPEG image.

Because the RST markers are identifiable in the resulting JPEG bit stream with MCU rotation 615, the transcoder 609 can locate each MCU individually. Each MCU can then be indexed, and the MCUs can be fetched in a reordered manner based on the indexing, so that the MCUs are positioned in a rotated order relative to the original encoded image. Therefore, rather than simply sequentially processing MCUs according to the order in which they appear in the input data stream, MCUs are extracted from different parts of the compressed image in accordance with the order in which the MCUs will appear in the output data stream. In this way, an encoded image that includes MCUs coded via DCT techniques can be rotated without decoding some or all of the DCT coefficients.

For example, during operation, the JPEG encoder 608 receives the image data 601. The JPEG encoder 608 may generate a JPEG bit stream of the image data 601 with each MCU rotated. In a particular embodiment, the rotated MCUs remain in the original order of the image data 601. The image data with rotated MCUs is illustrated as rotated image block 610 and as JPEG bit stream with MCU rotation 615. The JPEG encoder 608 may generate a JPEG bit stream in the received order with RST markers following every MCU to be used during indexing and reordering of the bit stream. The transcoder 609 receives the JPEG bit stream from the JPEG encoder 608, and after indexing at the index module 612, reordering at the reorder module 614, decoding at the decoder module 611, and differential coding at the differential coding module 613 according to the rotation order, the JPEG bit stream is ordered such that the rotation order performed by the JPEG encoder is decodable by a conventional JPEG decoder.

In a particular embodiment, the RST markers are removed from the JPEG bit stream of the rotated image 617 by the transcoder 609. The transcoder 609 performs Huffman decoding to extract DC coefficients for differential coding to remove the RST markers. The JPEG bit stream of the rotated image is shown illustratively at 616.

In the particular illustrative embodiment previously described, the indexing, the reordering, the decoding, and the differential coding are described above as occurring within the transcoder 609. However, in another embodiment, each operation, individually or in any combination thereof, may occur within the encoder 608.

Referring to FIG. 7, another particular embodiment of an image rotation system is depicted and generally designated 700. The system 700 includes a JPEG encoder 708 coupled to a transcoder 709. The transcoder 709 includes an index module 712 coupled to a reordering module 714. In a particular embodiment, the index module 712 uses RST markers to index MCUs of the JPEG bit stream, and the reordering module 714 fetches an MCU bit stream in rotation order.

The JPEG encoder 708 receives image data 701. A reordering of MCUs and rotation of image data within the MCUs by the JPEG encoder 708 and the transcoder 709 generates a rotated version of the image encoded in the image data 701.

Because the RST markers are identifiable in the resulting JPEG bit stream with MCU rotation 715, the transcoder 709 can locate each MCU individually. Each MCU can then be indexed, and the MCUs can be fetched in a reordered manner based on the indexing, so that the MCUs are positioned in a rotated order relative to the original encoded image.

For example, during operation, the JPEG encoder 708 receives the image data 701. The JPEG encoder 708 may generate a JPEG bit stream of the image data 701 with each MCU rotated and differentially encoded in rotation order, such as described with respect to FIG. 2. In a particular embodiment, the rotated MCUs remain in the original order of the image data 701. The image data with rotated MCUs is schematically illustrated as rotated image block 710 and as JPEG bit stream with MCU rotation 715. The JPEG encoder 708 may generate a JPEG bit stream in the received order with RST markers following every MCU to be used during indexing and reordering of the bit stream. The transcoder 709 receives the JPEG bit stream from the JPEG encoder 708, and after indexing at the indexing module 712 and reordering at the reordering module 714, the JPEG bit stream is ordered such that the differential coding in the rotation order performed by the JPEG encoder 708 is decodable by a conventional JPEG decoder. Therefore, the RST markers designating the beginning of each row of the image are retained, and the remaining RST markers are removed from the JPEG bit stream of the rotated image 717. The JPEG bit stream of the rotated image is shown illustratively at 716.

Although the indexing and the reordering are described above as occurring within the transcoder, in another embodiment the indexing, the reordering, or both the indexing and the reordering may occur within the encoder 708.

Referring to FIG. 8, a particular embodiment illustrating block process order and block scan order for various degrees of image rotation is depicted and generally designated 800. For example, a block process order of luminance (Y) data in a two block horizontal two block vertical (H2V2) MCU having two-by-two (2×2) luminance blocks at 0 degrees rotation (i.e., conventional encoding) is in a raster scan order: top left, top right, bottom left, bottom right. For a two block horizontal and one block vertical (H2V1) MCU having a two-by-one (2×1) luminance block at 0 degrees rotation, a block process order is also in the raster scan order of left, right. The block scan order for a general configuration of luminance and chroma (Cr, Cb) blocks is depicted for zero (0) degrees rotation.

A block process order of Y data in a H2V2 MCU having 2×2 luminance blocks at a ninety (90) degree rotation is in a raster scan order: top right, bottom right, top left, bottom left. For a H2V1 MCU having 2×1 luminance block at 90 degree rotation, a block process order is also in the raster scan order of top, bottom. The block scan order for a general configuration of luminance and chroma (Cr, Cb) blocks is depicted for a ninety (90) degree rotation.

A block process order of Y data in a H2V2 MCU having 2×2 luminance blocks at a one hundred eighty (180) degree rotation is in a raster scan order: bottom right, bottom left, top right, top left. For a H2V1 MCU having 2×1 luminance block at 180 degree rotation, a block process order is also in the raster scan order of right, left. The block scan order for a general configuration of luminance and chroma (Cr, Cb) blocks is depicted for a one hundred eighty (180) degree rotation.

A block process order of Y data in a H2V2 MCU having 2×2 luminance blocks at a two hundred seventy (270) degree rotation is in a raster scan order: bottom left, top left, bottom right, top right. For a H2V1 MCU having 2×1 luminance block at 270 degree rotation, a block process order is also in the raster scan order of bottom, top. The block scan order for a general configuration of luminance and chroma (Cr, Cb) blocks is depicted for a two hundred seventy (270) degree rotation.

Referring to FIG. 9, a particular embodiment illustrating block process order and block scan order for horizontal and vertical transitions of images is depicted and generally designated 900. For an image that is not rotated, the block process order and block scan order for each MCU matches the orders illustrated for a zero (0) degree rotation depicted in FIG. 8.

A block process order of Y data in a H2V2 MCU having 2×2 luminance blocks at a vertical transition or flip is a raster scan order: bottom left, bottom right, top left, top right. For a H2V1 MCU having 2×1 luminance block at a vertical transition, a block process order is also in the raster scan order of left, right.

A block process order of Y data in a H2V2 MCU having 2×2 luminance blocks at a horizontal transition or flip is a raster scan order: top right, top left, bottom right, bottom left. For a H2V1 MCU having 2×1 luminance block at a vertical transition, a block process order is also in the raster scan order of right, left.

Referring to FIG. 10, a flow diagram of a first particular illustrative embodiment of a method of rotating an image is depicted and generally designated 1000. Generally, the image rotation method 1000 may be performed by one or more of the systems depicted in FIGS. 1-7, by other image processing systems or devices, or any combination thereof. Image data corresponding to an image is received, at 1002. The image data includes a plurality of image blocks. A first differential DC value is calculated during a rotation operation of the image by comparing a first DC coefficient value of a first block of a first row of the image to a second DC coefficient value of a first block of a second row of the image, at 1004. In a particular embodiment, the first differential DC value may be calculated by differential DC calculation logic module 208 of FIG. 2. The first differential DC value is stored in a memory prior to completing the rotation operation, at 1006, such as the image storage 140 of FIG. 1. For example, an encoded MCU may be stored in the memory 216 of FIG. 2 as other blocks of the image data 209 continue to be processed by the block rotation module 213 of the encoder 202.

By calculating the first differential DC value during the rotation operation based on comparing the DC coefficient values of blocks in different rows, i.e., in a rotation order rather than in a scan order, an encoder may generate an output of image blocks that are differentially encoded to be readable by a decoder after the image blocks have been arranged in a rotation order. For example, a re-ordering of the image blocks for a 90 degree rotation may result in the rows of the original image forming columns of the rotated image, and the columns of the original image forming rows of the rotated image. By differentially encoding the image data in the rotation order (i.e., along columns rather than along rows) during the rotation operation, a later differential encoding operation need not be performed after the block reordering. Thus, additional processing to decode and retrieve the DC coefficients after encoding and storing to the memory, such as by a transcoder, may be avoided.

Referring to FIG. 11, a flow diagram of a second particular illustrative embodiment of a method of rotating an image is depicted and generally designated 1100. Generally, the image rotation method 1100 may be performed by one or more of the systems depicted in FIGS. 1-7, by other image processing systems or devices, or any combination thereof. For example, a portable electronic device having a camera may include a computer readable medium, such as a memory, that stores instruction code that is executable by a computer, such as a processor of the portable electronic device, to perform the method of rotating an image 1100.

A rotation signal may be received at an input of a hardware Joint Photographic Expert Group (JPEG) encoder, at 1102. In a particular embodiment, the rotation signal may be the rotation signal 220 of FIG. 2. In a particular embodiment, an image sensor of an image capture device may be responsive to the rotation signal. A scan order signal may be sent from the hardware JPEG encoder to an image capture device based on the rotation signal 220 to modify a scanning order at the image capture device. Image data corresponding to an image is received, at 1104. The image data includes a plurality of image blocks. The image data may be received as a first row of an image, followed directly by a second row of the image. A first DC coefficient value of the first block of the first row may be stored in a row buffer, at 1106. In a particular embodiment, the row buffer may be the row buffer 204 of FIG. 2. A first differential DC value is calculated by comparing a first DC coefficient value of a first block of a first row of the image to a second DC coefficient value of a first block of a second row of the image during a rotation operation of the image, at 1108. A second DC coefficient value of the first block of the second row may be stored in the row buffer, at 1110. Prior to completing the rotation operation, the first differential DC value is stored in a memory, at 1112, such as the image storage 140 of FIG. 1 or the memory 216 of FIG. 2.

A third DC coefficient value of a second block of the first row of the image may be stored, at 1114. A second differential DC value may be calculated by comparing a fourth DC coefficient value of a second block of the second row of the image to the third DC coefficient value of the second block of the first row of the image. The second differential DC value may be stored in the memory, such as the image storage 140 of FIG. 1 or the memory 216 of FIG. 2.

Encoded JPEG data including an RST marker and a DC coefficient may be received, and data in the RST marker may be overwritten to indicate a number of padding bits between an end of a bit stream of the last MCU and the RST marker, at 1116. The number of padding bits allows the end of the previous MCU bit stream to be more easily identified, which allows DC predictor values for luma (Y) and chroma (Cb, Cr) to be inserted for the last block in the MCU next to the RST marker. The DC predictor values may be used to apply differential coding across the MCU boundary so that the RST markers can be removed without having to decode parts of the bit stream. At a transcoder, data in the RST marker may be read to read the number of padding bits, to remove the RST marker, and to read the DC coefficient without decoding a JPEG data stream of the MCU, at 1118. Therefore in some embodiments, the transcoder can more efficiently substitute DC coefficients in the stored JPEG bit stream with differential DC values.

Referring to FIG. 12, a particular illustrative embodiment of a wireless communication device including a rotation operation module that uses rotation order differential encoding is depicted and generally designated 1200. The device 1200 includes a processor 1210, such as a general processor, a digital signal processor (DSP), or an image processor, coupled to a memory 1232 and also coupled to a rotation operation module that uses rotation order differential encoding 1264. In an illustrative example, the rotation operation module 1264 is executable using program instructions that are stored in the memory 1232 and that are executable by the processor 1210. In other embodiments, the rotation operation module 1264 may be implemented in hardware, firmware, or any combination thereof, and may operate in accordance with one or more of the embodiments depicted in FIGS. 1-11.

For example, the hardware and/or firmware to perform the rotation operation may be fully or partially implemented by any programmable or hardcoded logic, such as Field Programmable Gate Arrays (FPGAs), Transistor-Transistor-Logic (TTL), or Application Specific Integrated Circuits (ASICs).

A camera 1270 is coupled to the processor 1210 via a camera interface 1268. The camera 1270 may include a still camera, a video camera, or any combination thereof. The camera interface 1268 is adapted to control an operation of the camera 1270, including storing captured and processed image data 1280, at the memory 1232.

FIG. 12 also shows a display controller 1226 that is coupled to the processor 1210 and to a display 1228. A coder/decoder (CODEC) 1234 can also be coupled to the processor 1210. A speaker 1236 and a microphone 1238 can be coupled to the CODEC 1234.

FIG. 12 also indicates that a wireless interface 1240 can be coupled to the processor 1210 and to a wireless antenna 1242. In a particular embodiment, the processor 1210, the display controller 1226, the memory 1232, the CODEC 1234, the wireless interface 1240, the camera interface 1268, and the rotation operation module 1264 are included in a system-in-package or system-on-chip device 1222. In a particular embodiment, an input device 1230 and a power supply 1244 are coupled to the system-on-chip device 1222. Moreover, in a particular embodiment, as illustrated in FIG. 12, the display 1228, the input device 1230, the speaker 1236, the microphone 1238, the wireless antenna 1242, the camera 1270, and the power supply 1244 are external to the system-on-chip device 1222. However, each of the display 1228, the input device 1230, the speaker 1236, the microphone 1238, the wireless antenna 1242, the camera 1270, and the power supply 1244 can be coupled to a component of the system-on-chip device 1222, such as an interface or a controller.

Referring to FIG. 13, a block diagram of a particular illustrative embodiment of a system including a rotation operation module using rotation order differential encoding is depicted and generally designated 1300. The system 1300 includes an image sensor device 1322 that is coupled to a lens 1368 and that is also coupled to an application processor chipset of a portable multimedia device 1370. The image sensor device 1322 includes a rotation operation module 1364 that uses rotation order differential encoding to rotate image data prior to providing the image data to the application processor chipset 1370, such as by implementing one or more of the systems of FIGS. 1, 2, 7 or 13, by operating in accordance with any of the embodiments of FIGS. 4-6 or 8-11, or any combination thereof.

The rotation operation module 1364 is coupled to receive image data from an image array 1366, such as via an analog-to-digital convertor 1326 that is coupled to receive an output of the image array 1366 and to provide the image data to the rotation operation module 1364.

The image sensor device 1322 may also include a processor 1310. In a particular embodiment, the processor 1310 is configured to implement the rotation operation using rotation order differential encoding functionality. In another embodiment, the rotation operation module 1364 is implemented as separate image processing circuitry.

The processor 1310 may also be configured to perform additional image processing operations, such as one or more of the operations performed by the modules 112-120 of FIG. 1. The processor 1310 may provide processed image data to the application processor chipset 1370 for further processing, transmission, storage, display, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware in some embodiments or software in other embodiments depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method, comprising:
receiving image data of an image, the image data including a plurality of image blocks;
calculating a first differential DC value during a rotation operation of the image by comparing a first DC coefficient value of a first block of a first row of the image to a second DC coefficient value of a first block of a second row of the image; and
storing the first differential DC value in a memory prior to completing the rotation operation.

2. The method of claim 1, wherein the second row is received directly after the first row.

3. The method of claim 1, further comprising storing the first DC coefficient value in a buffer.

4. The method of claim 3, wherein the first DC coefficient value corresponds to a luma block of a first minimum coded unit (MCU), and further comprising storing a first chroma red DC coefficient value and a first chroma blue DC coefficient value corresponding to the first MCU at the buffer.

5. The method of claim 3, further comprising storing the second DC coefficient value in the buffer.

6. The method of claim 1, further comprising:
storing a third DC coefficient value of a second block of the first row of the image;
comparing a fourth DC coefficient value of a second block of the second row of the image to the third DC coefficient value of the second block of the first row of the image to calculate a second differential DC value; and
storing the second differential DC value in the memory.

7. The method of claim 1, wherein each block of the plurality of blocks is one of a plurality of blocks within a minimum coded unit (MCU) of the image.

8. The method of claim 7, wherein the MCU includes four luma blocks and two chroma blocks.

9. The method of claim 1, further comprising:
receiving a rotation signal at an input of a hardware encoder; and
sending a scan order signal from the hardware encoder to an image capture device based on the rotation signal to modify a scanning order at the image capture device.

10. The method of claim 9, wherein the hardware encoder comprises a hardware Joint Photographic Experts Group (JPEG) encoder.

11. The method of claim 9, wherein the rotation signal indicates an orientation of an image sensor.

12. The method of claim 1, further comprising:
receiving encoded joint photographic expert group (JPEG) data including a restart (RST) marker and a DC coefficient; and
overwriting data in the RST marker to indicate a number of padding bits between an end of a last minimum coded unit (MCU) and the RST marker.

13. The method of claim 12, wherein the DC coefficient is inserted adjacent to the RST marker and further comprising, at a transcoder, reading the data in the RST marker to read the number of padding bits, to remove the RST marker, and to read the DC coefficient without decoding a JPEG data stream of the MCU.

14. The method of claim 1, wherein the first differential DC value is stored as an entropy-encoded value.

15. An apparatus comprising:
a block rotation module configured to receive image data of an image, the image data including a plurality of image blocks; and
a differential DC calculation module coupled to the block rotation module and configured to calculate a differential DC value during a rotation operation of the image by comparing a first DC coefficient value of a first block of a first row of the image to a second DC coefficient value of a first block of a second row of the image.

16. The apparatus of claim 15, further comprising a buffer coupled to the differential DC calculation module, wherein the first DC coefficient value is stored in the buffer and the second DC coefficient value is stored in the buffer.

17. The apparatus of claim 16, wherein the first DC coefficient value corresponds to a luma block of a first minimum coded unit (MCU), and further comprising storing a first chroma red DC coefficient value and a first chroma blue DC coefficient value corresponding to the first MCU at the buffer.

18. The apparatus of claim 15, further comprising a transcoder coupled to the differential DC calculation module, wherein the transcoder is configured to receive encoded joint photographic expert group (JPEG) data including a restart (RST) marker and a DC coefficient and to overwrite data in the RST marker to indicate a number of padding bits between an end of a last minimum coded unit (MCU) and the RST marker.

19. The apparatus of claim 18, further comprising:
a camera that captures the image; and
an encoder configured to generate the encoded JPEG data.

20. The apparatus of claim 18, wherein the encoded DC coefficient is received prior to the RST marker.

21. An apparatus comprising:
means for receiving image data of an image, the image data including image blocks; and
means for calculating a first differential DC value during a rotation operation of the image by comparing a first DC coefficient value of a first block of a first row of the image to a second DC coefficient value of a first block of a second row of the image,
wherein said means for calculating a first differential DC value is coupled to said means for receiving image data.

22. The apparatus of claim 21, further comprising:
means for encoding the received image data, wherein the image data corresponds to a raster scan of the image to undergo a rotation, the image having multiple rows and multiple columns of image blocks;
means for encoding an image block to represent rotated image data in an encoded image block;
means for determining a readout position of the encoded image block in a readout order based on the rotation of the image;
means for generating a differential DC value of the encoded image block according to the readout position; and
means for storing the encoded image block.

23. The apparatus of claim 21, further comprising means for receiving encoded joint photographic expert group (JPEG) data including a restart (RST) marker and a DC coefficient, and means for overwriting data in the RST marker to indicate a number of padding bits between an end of a last minimum coded unit (MCU) and the RST marker.

24. The apparatus of claim 22, further comprising means for retrieving the encoded image block in the readout order.

25. A computer readable storage medium storing computer executable code, comprising:
code executable by a computer to store a first DC coefficient value of a first block of a first row of an image during a rotation operation of the image;
code executable by the computer to compare a second DC coefficient value of a first block of a second row of the image to the first DC coefficient value to calculate a first differential DC value; and
code executable by the computer to store the first differential DC value prior to completing the rotation operation.

26. The computer readable storage medium of claim 25, further comprising:
code executable by the computer to store a third DC coefficient value of a second block of the first row of the image;
code executable by the computer to compare a fourth DC coefficient value of a second block of the second row of the image to the second block of the first row of the image to calculate a second differential DC value; and
code executable by the computer to store the second differential DC value.

27. The computer readable storage medium of claim 25, further comprising:
code executable by the computer to receive a rotation signal at an input of a hardware joint photographic experts group (JPEG) encoder; and
code executable by the computer to send a scan order signal from the hardware JPEG encoder to an image capture device based on the rotation signal to modify a scanning order at the image capture device.

28. The computer readable storage medium of claim 25, further comprising:
code executable by the computer to receive encoded Joint Photographic Expert Group (JPEG) data including a restart (RST) marker and a DC coefficient; and
code executable by the computer to overwrite data in the RST marker to indicate a number of padding bits between an end of a last minimum coded unit (MCU) and the RST marker.
